(19) United States
(12) Patent Application Publication
(10) Pub. No.: US 2026/0079332 A1
(43) Pub. Date: Mar. 19, 2026

(54) HOT-WIRE DEPOSITION DEVICE WITH EXTENDED FOCAL-ZONE LASER BEAM

(71) Applicant: Suzhou Focuring Laser Technology Co., Ltd., Suzhou City (CN)

(72) Inventors: Tuo SHI, Suzhou City (CN); Chao WEI, Suzhou City (CN); Shaoshan JI, Suzhou City (CN); Rongwei ZHANG, Suzhou City (CN); Jiangling WANG, Suzhou City (CN); Shihong SHI, Suzhou City (CN)

(21) Appl. No.: 19/295,989

(22) Filed: Aug. 11, 2025

(30) Foreign Application Priority Data
Sep. 14, 2024 (CN) 202411292455.5

(51) Int. Cl. G02B 17/00; B22F 12/41; B22F 12/49; B23K 26/06; B23K 26/073; B23K 26/342; B33Y 30/00; G02B 5/00; G02B 27/10

(52) U.S. Cl. CPC G02B 17/002; B22F 12/41; B22F 12/49; B23K 26/0643; B23K 26/0665; B23K 26/0734; B23K 26/342; B33Y 30/00; G02B 27/106; G02B 5/001

(57) ABSTRACT

A hot-wire deposition device with an extended focal-zone laser beam includes a laser, a lens assembly, a deposition working surface and a wire feeding system. The laser is configured to emit a laser beam; the lens assembly is configured to transform the laser beam into an extended focal-zone laser beam, which transitions from an annular light spot to a continuous solid light spot in a space. The deposition working surface is configured to receive a projection of the extended focal-zone laser beam to obtain a solid or annular light spot and a molten pool formed by sustained heating of the light spot. The wire feeding system is configured to feed a wire along a preset path, making a tail end of the wire connected to the molten pool in the form of a liquid bridge after being preheated by the continuous solid light spot.

### CROSS-REFERENCE TO RELATED APPLICATION

This patent application claims the benefit and priority of Chinese Patent Application No. 202411292455.5 filed with the China National Intellectual Property Administration on Sep. 14, 2024, the disclosure of which is incorporated by reference herein in its entirety as part of the present application.

### TECHNICAL FIELD

The present disclosure relates to the technical field of laser wire deposition, and in particular to a hot-wire deposition device with an extended focal-zone laser beam.

### BACKGROUND

Laser melting deposition (LMD) technology is an important branch in the field of metal additive manufacturing technology, which can be divided into a powder feeding type and a wire feeding type according to the form of feed materials. Compared with powder feeding LMD, the wire feeding LMD mainly has advantages as follows. Firstly, a metal wire is easier to prepare and convenient to store than metal powder, so purchasing and storage costs of the wire of a same material can be greatly reduced. Secondly, according to process characteristics, the wire feeding LMD has higher material utilization rate (material utilization rate is approximately equal to 100%) and deposition efficiency, and the additive manufacturing process is more green and environmentally friendly, without powder particle pollution. Finally, because a surface area ratio of the metal wire is much smaller than that of the metal powder, the doping of unfavorable gases such as oxygen can be significantly reduced in the process of laser melting deposition in an open environment, which can further reduce an oxidation degree of the deposition layer and reduce the porosity. Based on the foregoing advantages, the wire feeding LMD technology has been widely concerned in recent years.

At present, the wire-feeding LMD technology is still dominated by a paraxial wire-feeding method (a wire-feeding direction is different from an optical axis of a laser beam), such as CN108188581A. The paraxial wire feeding method is simple in system layout but has the disadvantages of poor laser-wire coupling and nonuniform laser energy distribution. The foregoing problems can be effectively solved by using a laser-wire coupling method with coaxial arrangement of laser and wires (multi-beam coaxial wire feeding and annular beam coaxial wire feeding). The LMD by coaxial wire feeding within annular beam has more uniform energy distribution and more stable process adaptability, which is an important research direction of the coaxial wire feeding LMD technology. At present, all working light sources for the coaxial wire feeding within annular beam are focused light sources, and a laser source finally converges to a focal point through an optical path conversion system. This heat source has the characteristics of energy concentration. However, for the wire feeding LMD, a relative position between the wire end and the laser heat source is often limited. Generally, the best deposition effect can be obtained by taking a working light spot with an annular light spot having a hollow diameter equal to a diameter of the wire.

In the process of wire feeding LMD, a cold wire entering into a rapidly fusing and solidifying pool induces a chilling effect on the pool, which may even cause an insufficient melting wire to contact the bottom of the molten pool, making the wire bounced out from the bottom of the molten pool due to a force. Entry of a preheated metal wire into the molten pool can assist rapid melting and form stable melt convection, thereby further improving deposition efficiency of LMD. In addition, in the case of the cold wire, after the wire with insufficient straightening is sent out from a wire feeding nozzle, due to its own curvature, the tail end of the wire cannot accurately enter a predetermined vertical region, which affects a wire feeding accuracy. The research shows that in the case that the wire is preheated, the molten wire, under the tension exerted by the substrate molten pool, exhibits a tendency for molten droplets to adhere to the center of the molten pool at an expected position, provided that the size of the molten pool is large enough and the molten droplets are in the liquid molten pool region. This self-adaptive behavior of hot wire transition helps enhance accuracy and stability of LMWD (Laser metal wire deposition) forming process.

The current wire preheating methods can be mainly divided into resistive heating and inductive heating in principle, but all methods require the introduction of either auxiliary preheating devices or additional heat sources. For example, in CN109514068A and CN110238528A, a wire is preheated by adopting an induction coil or adding a second laser heat source. The foregoing methods, a complete set of inductive/resistive hot wire equipment or an additional laser generator needs to be additionally introduced. Moreover, it is clear that all the foregoing methods adopt a paraxial wire feeding forming technology, because a structure of the paraxial wire feeding processing head is often not compact, and a wire preheating region before a deposition position needs to have enough space to arrange other auxiliary wire heating devices such as a second heat source. In addition, the way of preheating the wire by adding the auxiliary preheating device often leads to a long preheating interruption distance, which may reduce an original preheating effect on the wire and reduces the energy utilization rate. Improper preheating power selection can easily lead to process failure.

For an annular laser coaxial wire feeding head, because the deposition position is located in a beam focusing region, the wire preheating region often does not have enough space for the arrangement of additional devices. In addition, based on the reason of avoiding optical path interference, it is difficult to implement the connection between the wire preheating region inside the optical path and an external preheating system. To solve the problem of wire preheating of LMD technology with annular laser coaxial wire feeding, the inventor invented a coaxial feeding laser cladding device (CN106583920A), where a homologous laser beam is divided into two beams by different conical reflection angles of a same conical mirror, one beam is used to act on a working interface to form a molten pool for material deposition, and the other beam is used to preheat a fed material. However, the wire preheating range is limited, and there is an unheated region between the wire preheating region and the molten pool region, making it unable to implement continuous preheating of the wire before entering the molten pool. In addition, this method cannot adjust the energy distribution of two laser beams with different functions independently, which is not conducive to the development of the LMD process for multi-material.

### SUMMARY

An objective of the present disclosure is to provide a hot-wire deposition device with an extended focal-zone laser beam, which can implement regulation of a temperature gradient of a deposition layer and deposition quality of a material while improving the stability and material deposition efficiency of LMD with coaxial wire feeding.

To achieve the objective above, the present disclosure provides the following technical solutions.

The present disclosure discloses a hot-wire deposition device with an extended focal-zone laser beam, including:

a laser configured to emit a laser beam;

a lens assembly configured to transform the laser beam into an extended focal-zone laser beam, where the extended focal-zone laser beam transitions from an annular light spot to a continuous solid light spot in a space;

a deposition working surface configured to receive a projection of the extended focal-zone laser beam, so that a solid or annular light spot and a molten pool formed by sustained heating of the light spot is obtained. By adjusting the position of the deposition working surface in the extended focal-zone laser beam, the size and energy distribution pattern (solid or circular) of the light spot can be changed, thereby obtaining deposition morphologies with different widths.

A wire feeding system configured to feed a wire along a preset path, so that a tail end of the wire connects to the molten pool in a form of a liquid bridge after being preheated by the continuous solid light spot.

Preferably, the lens assembly includes a beam splitter and a mirror; the beam splitter is provided with a conical outer reflecting surface, the mirror is provided with a conical inner reflecting surface, and the outer reflecting surface and the inner reflecting surface are coaxial; and the outer reflecting surface is configured to expand an incident laser beam, and the inner reflecting surface is configured to combine the laser beam expanded by the outer reflecting surface, so as to obtain the extended focal-zone laser beam.

Preferably, the lens assembly includes a beam splitter and a mirror; the beam splitter is provided with a conical outer reflecting surface, the mirror is provided with an inner reflecting surface with a parabolic shape, and the outer reflecting surface and the inner reflecting surface are coaxial; and the outer reflecting surface is configured to expand an incident laser beam, and the inner reflecting surface is configured to combine the laser beam expanded by the outer reflecting surface, so as to obtain the extended focal-zone laser beam.

Preferably, the lens assembly includes a beam-splitting axicon, a collimating lens and a beam-combining axicon; the beam-splitting axicon, the collimating lens and the beam-combining axicon are arranged sequentially and coaxially; the beam-splitting axicon is configured to expand an incident laser beam, the collimating lens is configured to collimate the laser beam expanded by the beam-splitting axicon, and the beam-combining axicon is configured to combine the collimated laser beam emitted from the collimating lens, so as to obtain the extended focal-zone laser beam.

Preferably, the lens assembly includes a beam splitter, a mirror and a beam-combining axicon; the beam splitter is provided with a conical outer reflecting surface, the mirror is provided with a conical inner reflecting surface, and the outer reflecting surface, the inner reflecting surface and the beam-combining axicon are coaxial; the outer reflecting surface is configured to expand an incident laser beam; the inner reflecting surface is configured to collimate the laser beam expanded by the outer reflecting surface, and the beam-combining axicon is configured to combine the collimated laser beam obtained by the inner reflecting surface, so as to obtain the extended focal-zone laser beam.

Preferably, the lens assembly further includes a planar mirror or an integral mirror, where the planar mirror or the integral mirror is configured to change a processing direction or laser energy distribution of the extended focal-zone laser beam.

Preferably, the lens assembly further includes a regulation mechanism, the regulation mechanism is configured to regulate a position of one or more parts of the lens assembly, thereby regulating the extended focal-zone laser beam.

Preferably, an optical axis of the extended focal-zone laser beam is perpendicular to the deposition working surface.

Preferably, a length of the continuous solid light spot along the optical axis of the extended focal-zone laser beam is an effective preheating length, the effective preheating length is greater than 5 mm.

Preferably, a preheating length of the wire is not greater than 20 mm.

Compared with the prior art, some embodiments have the following technical effects.

A part of the extended focal-zone laser beam irradiates the wire entering the continuous solid light spot to preheat the wire, and the other part of the extended focal-zone laser beam irradiates the deposition working surface to form a molten pool on the deposition working surface. The wire is continuously preheated and enters the molten pool of a substrate in a form of a hot-wire semi-molten state to form a liquid bridge, thereby implementing stable and efficient material deposition. In addition, preheating the wire can significantly reduce a chilling effect of the wire on the molten pool, reduce the temperature gradient and internal stress, promote the stable formation of liquid bridge transition, and significantly improve the deposition efficiency and quality of the material.

### BRIEF DESCRIPTION OF THE DRAWINGS

To describe the technical solutions of embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a diagram of a structure of a hot-wire deposition device with an extended focal-zone laser beam according to an embodiment of the present disclosure;

FIG. 2 is a diagram of another structure of a hot-wire deposition device with an extended focal-zone laser beam according to an embodiment of the present disclosure;

FIG. 3 is a first example of a lens assembly;

FIG. 4 is a second example of a lens assembly;

FIG. 5 is a third example of a lens assembly;

FIG. 6 is a fourth example of a lens assembly;

FIG. 7 is a fifth example of a lens assembly;

FIG. 8 is a diagram showing different positional relationships between an extended focal-zone laser beam and a deposition working surface;

FIG. 9 is a diagram of a light spot at part A in FIG. 2;

FIG. 10 is a diagram of a hollow light spot of a conventional annular beam with a high duty ratio in the prior art;

FIG. 11 is a photograph of a light spot when a hot-wire deposition device with an extended focal-zone laser beam according to an embodiment of the present disclosure is in operation;

FIG. 12 is a photograph of a light spot during cold-wire deposition using a conventional annular beam.

In the drawings: 1 laser; 11 collimating lens; 2 lens assembly; 3 deposition working surface; 4 wire feeding system; 5 motion execution mechanism; 6 processing head; 21 beam splitter; 22 mirror; 23 beam-splitting axicon; 24 collimating lens; 25 beam-combining axicon; and 41 wire.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

An objective of the present disclosure is to provide a hot-wire deposition device with an extended focal-zone laser beam, which can implement regulation of a temperature gradient of a deposition layer and deposition quality of a material while improving the stability and material deposition efficiency of LMD with coaxial wire feeding.

To make the objectives, features and advantages of the present disclosure more clearly, the present disclosure is further described in detail below with reference to the accompanying drawings and specific implementations.

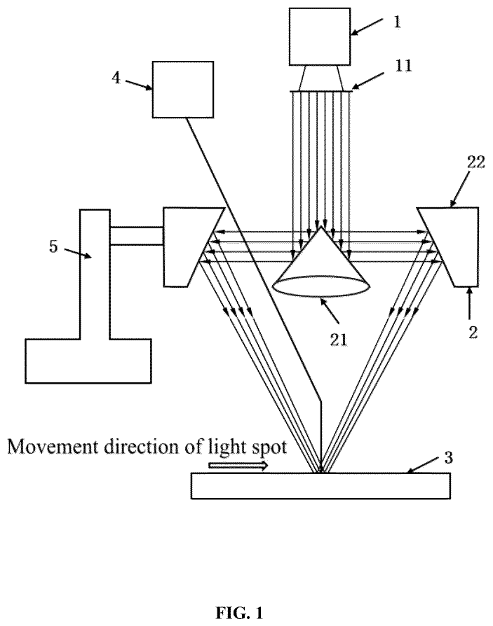

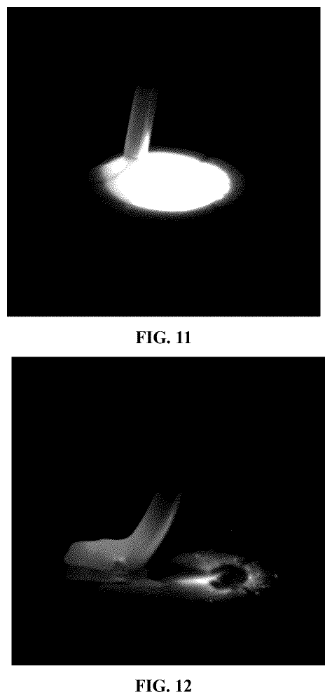

With reference to FIG. 1 to FIG. 9 and FIG. 11, this embodiment provides a hot-wire deposition device with an extended focal-zone laser beam, including a laser 1, a lens assembly 2, a deposition working surface 3, and a wire feeding system 4.

The laser 1 is configured to emit a laser beam. The lens assembly 2 is configured to transform the laser beam into an extended focal-zone laser beam, where the extended focal-zone laser beam transitions from an annular light spot to a continuous solid light spot in a space. The deposition working surface 3 is configured to receive a projection of the extended focal-zone laser beam to obtain a solid or annular light spot and a molten pool formed by sustained heating of the light spot. By adjusting a position of the deposition working surface 3 in the extended focal laser beam, the size and energy distribution mode (solid or annular) of the spot can be changed, thereby obtaining deposition morphologies with different widths. The wire feeding system 4 is configured to feed a wire 41 along a preset path, making tail end of the wire 41 connected to the molten pool in the form of a liquid bridge after being preheated by the continuous solid light spot. In this embodiment, the tail end of the wire 41 refers to one end, close to the deposition working surface 3, of the wire 41, which refers to only an end of a solid portion of the wire 41, and does not include the liquid bridge.

A working principle of the hot-wire deposition device with the extended focal-zone laser beam in this embodiment is as follows.

A part of the extended focal-zone laser beam irradiates the wire 41 entering the continuous solid light spot to preheat the wire 41, and the other part of the extended focal-zone laser beam irradiates the deposition working surface 3 to form the molten pool on the deposition working surface 3. The wire 41 is continuously preheated and enters the molten pool of a substrate in the form of a hot-wire semi-molten state so as to form a liquid bridge, thereby implementing stable and efficient material deposition. In addition, preheating the wire 41 can significantly reduce a chilling effect of the wire 41 on the molten pool, reduce the temperature gradient and internal stress, promote the stable formation of liquid bridge transition, and significantly improve the deposition efficiency and quality of the material.

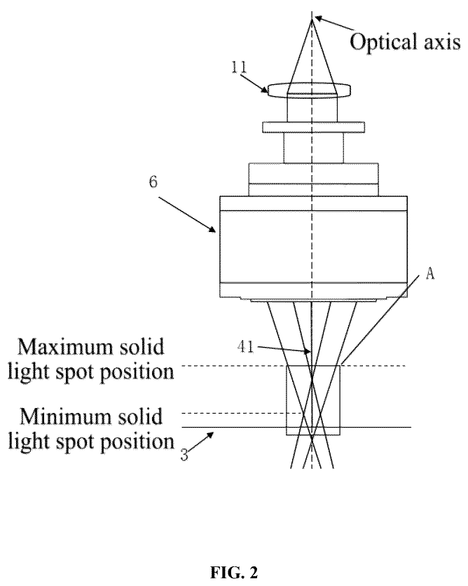

If the laser beam emitted by the laser 1 is a collimated laser beam, which can directly enter the lens assembly 2. In FIG. 1 and FIG. 2, the laser beam emitted by the laser 1 is a diffused laser beam, which is transformed into a collimated laser beam after being adjusted by a collimator lens 11, and then enters the lens assembly 2.

In FIG. 2, any two of an x axis, a y axis and a z axis are perpendicular to each other, the z axis is parallel to an optical axis of the extended focal-zone laser beam, and is perpendicular to the deposition working surface 3. In the continuous solid light spot, the wire 41 extends along an optical axis of the continuous solid light spot. The continuous solid spot of the extended focal laser beam has a position which has a minimum light spot, and from which light spot area increases gradually upward or downward.

FIG. 8 shows a continuous solid light spot at an upper side of the minimum light spot position; when the deposition working surface 3 corresponds to three different z-axis coordinates in this region (the continuous solid spot at the upper side of the minimum light spot position), the size of the light spot on the deposition working surface 3 changes. Deposition morphologies with different widths can be obtained by changing the size and energy distribution mode of the light spot; and a situation when the end of the wire 41 corresponds to three different z-axis coordinates in this region is shown. It is not difficult to learn that because the cross-sectional area of the wire 41 remains unchanged, when a radius of the light spot decreases, the laser energy distributed on the wire 41 increases, and the laser energy distributed on the deposition working surface 3 decreases. According to this rule, by changing the z-axis coordinates of the deposition working surface 3, a distribution ratio of the laser energy in preheating of the wire 41 and heating of the deposition working surface 3 can be adjusted to achieve the required effect. Similarly, it is not difficult to learn that when the tail end of the wire 41 is located outside this region, the wire 41 cannot be preheated by the extended focal-zone laser beam. When the tail end of the wire 41 is located in this region, a preheating length of the wire 41 increases as the distance between the tail end of the wire 41 and the deposition working surface 3 decreases. When a feeding rate of the wire 41 remains unchanged, the greater the preheating length of the wire 41, the longer the preheated time, and the more the laser energy received by the wire 41 per unit length. Therefore, a preheating effect of the wire 41 can be regulated by adjusting z-axis coordinates corresponding to the tail end of the wire 41. It should be noted that when the z-axis coordinates of the tail end of the wire 41 are adjusted, the tail end of the 41 should not be too far away from the deposition working surface 3, thereby ensuring stable formation of liquid bridge transition.

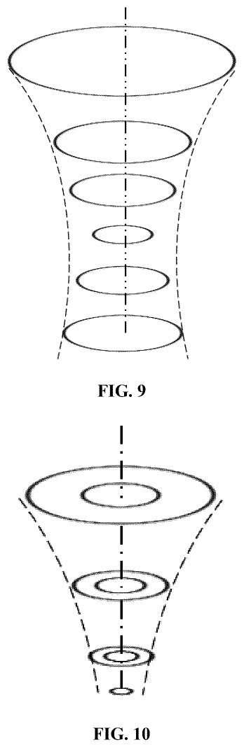

FIG. 9 shows condition where a light spot changes in a region A in FIG. 2 along a z-axis direction. Compared with the light spot in FIG. 10, the laser energy distribution is more uniform due to the adoption of the extended focal-zone laser beam.

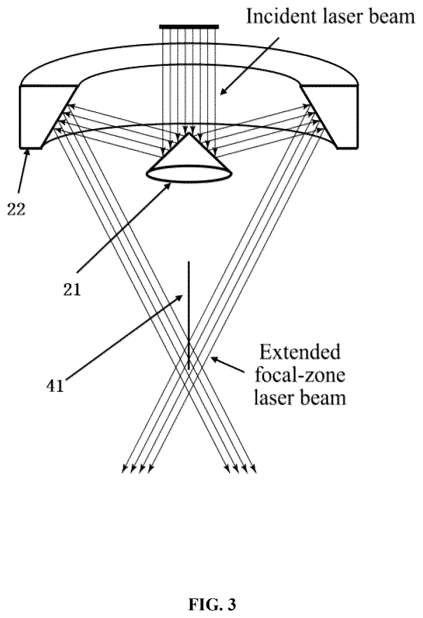

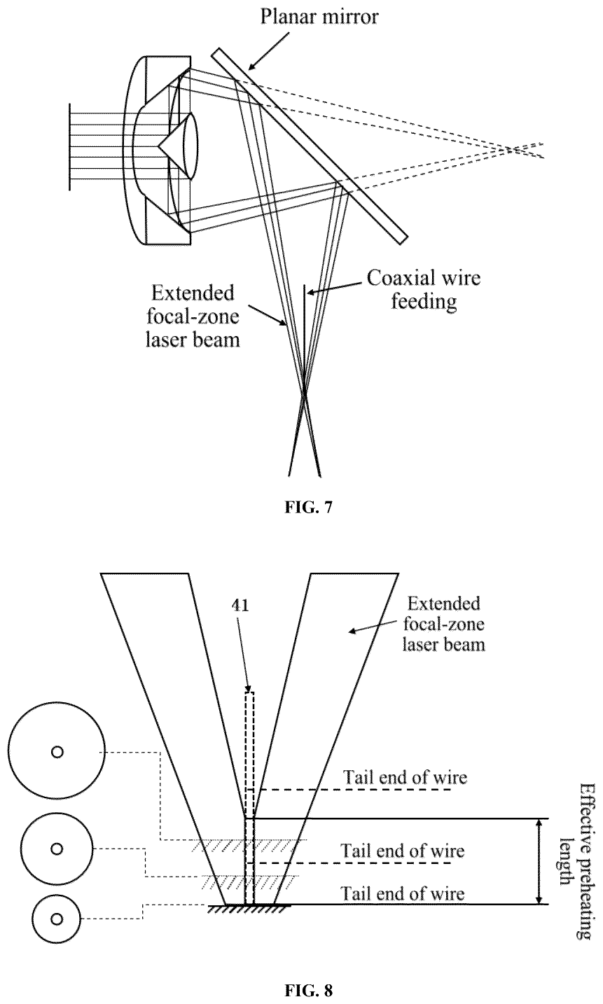

There are many types of lens assembly 2 for transforming the laser beam into an extended focal-zone laser beam, which can be selected by those skilled in the art according to actual needs. FIG. 3 and FIG. 7 show five examples of the lens assembly 2, but practical implementations are not limited thereto.

As a possible example, referring to FIG. 3, the lens assembly 2 includes a beam splitter 21 and a mirror 22. The beam splitter 21 is provided with a conical outer reflecting surface, and the mirror 22 is provided with a conical inner reflecting surface, where the outer reflecting surface and the inner reflecting surface are coaxial. The outer reflecting surface is configured to expand an incident laser beam, and the inner reflecting surface is configured to combine the laser beam expanded by the outer reflecting surface so as to obtain the extended focal-zone laser beam.

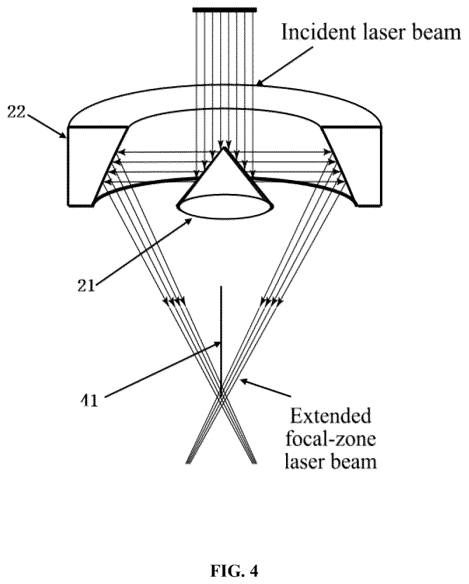

As a possible example, referring to FIG. 4, the lens assembly 2 includes a beam splitter 21 and a mirror 22. The beam splitter 21 is provided with a conical outer reflecting surface, and the mirror 2 is provided with a parabolic-shaped inner reflecting surface, where the outer reflecting surface and the inner reflecting surface are coaxial. The outer reflecting surface is configured to expand the incident laser beam, and the inner reflecting surface is configured to combine the laser beam expanded by the outer reflecting surface so as to obtain the extended focal-zone laser beam.

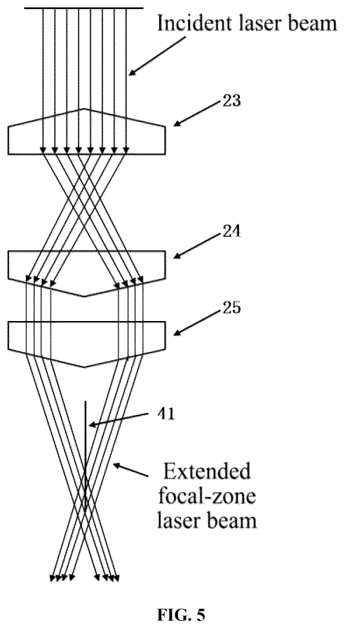

As a possible example, with reference to FIG. 5, the lens assembly 2 includes a beam-splitting axicon 23, a collimating lens 24, and a beam-combining axicon 25. The beam-splitting axicon 23, the collimating lens 24 and the beam-combining axicon 25 are arranged sequentially and coaxially. The beam-splitting axicon 23 is configured to expand the incident laser beam, the collimating lens 24 is configured to collimate the laser beam expanded by the beam-splitting axicon 23, and the beam-combining axicon 25 is configured to combine the collimated laser beam emitted from the collimating lens 24 so as to obtain the extended focal-zone laser beam.

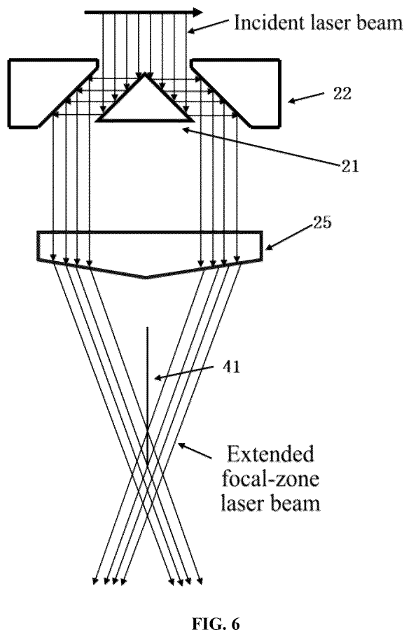

As a possible example, referring to FIG. 6, the lens assembly 2 includes a beam splitter 21, a mirror 22 and a beam-combining axicon 25. The beam splitter 21 is provided with a conical outer reflecting surface, the mirror 2 is provided with a conical inner reflecting surface, and the outer reflecting surface, the inner reflecting surface and the beam-combining axicon 25 are coaxial. The outer reflecting surface is configured to expand the incident laser beam, and the inner reflecting surface is configured to collimate the laser beam expanded by the outer reflecting surface. The beam-combining axicon 25 is configured to combine the collimated laser beam obtained by the inner reflecting surface so as to obtain the extended focal-zone laser beam.

As a possible example, with reference to FIG. 7, the lens assembly further includes a planar mirror or an integral mirror, where the planar mirror or the integral mirror is configured to change a process direction or laser energy distribution of the extended focal-zone laser beam.

As a possible example, the lens assembly 2 further includes a regulation mechanism, which is configured to regulate a position of one or more parts in the lens assembly 2, thereby regulating the extended focal-zone laser beam. For the lens assembly 2 shown in FIG. 3, FIG. 4 and FIG. 6, the regulation here may be to regulate a relative distance between the beam splitter 21 and the mirror 22 along the z axis. For the lens assembly 2 shown in FIG. 5, the regulation here may be to regulate a relative distance between the beam-splitting axicon 23 and the collimating lens 24 along the z axis, or a relative distance between the collimating lens 24 and the beam-combining axicon 25 along the z axis. For example, the lens here may be the mirror 22 in FIG. 3, FIG. 4 and FIG. 6, or the beam-combining axicon 25 in FIG. 5, where a movement direction of the regulation mechanism is a z-axis direction.

As a possible example, with reference to FIG. 1 and FIG. 2, the optical axis of the extended focal-zone laser beam is perpendicular to the deposition working surface 3, and the shape of the solid light spot irradiated on the deposition working surface 3 is circular. It may be understood that according to the actual needs, the optical axis of the extended focal-zone laser beam may also form a certain included angle with the z axis (for example, an included angle less than 10°).

As a possible example, in this embodiment, a cone apex angle of the outer reflecting surface is not less than 90°. Specifically, in examples corresponding to FIG. 3 and FIG. 6, the cone apex angle of the outer reflecting surface is 100°. In an example corresponding to FIG. 4, a cone apex angle of the outer reflecting surface is 90°.

As a possible example, with reference to FIG. 1, in this embodiment, the hot-wire deposition device with the extended focal-zone laser beam further includes a motion actuating mechanism 5. With reference to FIG. 2, the laser 1 and the lens assembly 2 are integrated on a processing head 6, and the motion actuating mechanism 5 is configured to move the processing head 6. When the motion actuating mechanism 5 moves the processing head 6 parallel to the z axis, the size of the light spot on the deposition working surface 3 can be adjusted. When the motion actuating mechanism 5 moves the processing head 6 in a direction perpendicular to the z axis, the light spot can move on the deposition working surface 3.

As a possible example, in this embodiment, a length of the continuous solid light spot along the optical axis of the extended focal-zone laser beam is called an effective preheating length, which is greater than 5 mm, thereby improving the preheating effect as much as possible.

As a possible example, in this embodiment, a preheating length of the wire 41 is not greater than 20 mm. It may be understood that the preheating length of the wire 41 can be flexibly adjusted, especially when the feeding rate of the wire 41 is changed, the preheating length of the wire 41 can be correspondingly adjusted to make the heat received per unit length constant or approximately constant.

As a possible example, in this embodiment, with reference to FIG. 1 to FIG. 7, in the continuous solid light spot, the wire 41 extends along the optical axis of the continuous solid light spot, that is, the wire 41 is coaxial with the extended focal-zone laser beam.

In the following, specific parameters of the hot-wire deposition device with the extended focal-zone laser beam in this embodiment is described with the following example: the motion actuating mechanism 5 moves the processing head 6 in a direction perpendicular to the z axis, and a moving speed of the processing head 6 is 10 mm/s, thereby forming a single cladding track with a length of 40 mm on the deposition working surface 3. The laser 1 has an output power of 2600 W, and a working distance of 6 mm, at this time, a diameter of the solid light spot on the deposition working surface 3 is 8 mm. The wire 41 is Ti6Al4V titanium alloy, which has a diameter of 1 mm and a preheating length of 6 mm. About 84% of the energy of the extended focal-zone beam acts on the deposition working surface 3 in a deep melting mode to form a molten pool, and the other 16% of the energy acts on the wire 41 to preheat the wire 41 in a thermal conduction mode.

Specific examples are used in the present disclosure for illustration of the principles and implementations of the present disclosure. The description of the embodiments is merely used to help illustrate the method and its core principles of the present disclosure. In addition, those of ordinary skill in the art can make various modifications in terms of specific implementations and scope of application in accordance with the teachings of the present disclosure. In conclusion, the content of this specification shall not be construed as a limitation to the present disclosure.

What is claimed is:

1. A hot-wire deposition device with extended focal-zone laser beam, comprising
a laser configured to emit a laser beam;
a lens assembly configured to transform the laser beam into an extended focal-zone laser beam, wherein the extended focal-zone laser beam transitions from an annular light spot to a continuous solid light spot in a space;
a deposition working surface configured to receive a projection of the extended focal-zone laser beam, so that a solid or annular light spot and a molten pool formed by sustained heating of the light spot is obtained; and
a wire feeding system configured to feed a wire along a preset path, so that a tail end of the wire connects to the molten pool in a form of a liquid bridge after being preheated by the continuous solid light spot.

2. The hot-wire deposition device with extended focal-zone laser beam according to claim 1, wherein the lens assembly comprises a beam splitter and a mirror; the beam splitter is provided with a conical outer reflecting surface, the mirror is provided with a conical inner reflecting surface, and the outer reflecting surface and the inner reflecting surface are coaxial; and the outer reflecting surface is configured to expand an incident laser beam, and the inner reflecting surface is configured to combine the laser beam expanded by the outer reflecting surface, so as to obtain the extended focal-zone laser beam.

3. The hot-wire deposition device with extended focal-zone laser beam according to claim 1, wherein the lens assembly comprises a beam splitter and a mirror; the beam splitter is provided with a conical outer reflecting surface, the mirror is provided with an inner reflecting surface with a parabolic shape, and the outer reflecting surface and the inner reflecting surface are coaxial; and the outer reflecting surface is configured to expand an incident laser beam, and the inner reflecting surface is configured to combine the laser beam expanded by the outer reflecting surface, so as to obtain the extended focal-zone laser beam.

4. The hot-wire deposition device with extended focal-zone laser beam according to claim 1, wherein the lens assembly comprises a beam-splitting axicon, a collimating lens and a beam-combining axicon; the beam-splitting axicon, the collimating lens and the beam-combining axicon are arranged sequentially and coaxially; the beam-splitting axicon is configured to expand an incident laser beam, the collimating lens is configured to collimate the laser beam expanded by the beam-splitting axicon, and the beam-combining axicon is configured to combine the collimated laser beam emitted from the collimating lens, so as to obtain the extended focal-zone laser beam.

5. The hot-wire deposition device with extended focal-zone laser beam according to claim 1, wherein the lens assembly comprises a beam splitter, a mirror and a beam-combining axicon; the beam splitter is provided with a conical outer reflecting surface, the mirror is provided with a conical inner reflecting surface, and the outer reflecting surface, the inner reflecting surface and the beam-combining axicon are coaxial; the outer reflecting surface is configured to expand an incident laser beam; the inner reflecting surface is configured to collimate the laser beam expanded by the outer reflecting surface, and the beam-combining axicon is configured to combine the collimated laser beam obtained by the inner reflecting surface, so as to obtain the extended focal-zone laser beam.

6. The hot-wire deposition device with extended focal-zone laser beam according to claim 2, wherein the lens assembly further comprises a planar mirror or an integral mirror, where the planar mirror or the integral mirror is configured to change a processing direction or laser energy distribution of the extended focal-zone laser beam.

7. The hot-wire deposition device with extended focal-zone laser beam according to claim 1, wherein the lens assembly further comprises a regulation mechanism, the regulation mechanism is configured to regulate a position of one or more parts of the lens assembly, thereby regulating the extended focal-zone laser beam.

8. The hot-wire deposition device with extended focal-zone laser beam according to claim 1, wherein an optical axis of the extended focal-zone laser beam is perpendicular to the deposition working surface.

9. The hot-wire deposition device with extended focal-zone laser beam according to claim 8, wherein a length of the continuous solid light spot along the optical axis of the extended focal-zone laser beam is an effective preheating length, the effective preheating length is greater than 5 mm.

10. The hot-wire deposition device with extended focal-zone laser beam according to claim 1, wherein a preheating length of the wire is not greater than 20 mm.

11. The hot-wire deposition device with extended focal-zone laser beam according to claim 3, wherein the lens assembly further comprises a planar mirror or an integral mirror, where the planar mirror or the integral mirror is configured to change a processing direction or laser energy distribution of the extended focal-zone laser beam.

12. The hot-wire deposition device with extended focal-zone laser beam according to claim 4, wherein the lens assembly further comprises a planar mirror or an integral mirror, where the planar mirror or the integral mirror is configured to change a processing direction or laser energy distribution of the extended focal-zone laser beam.

13. The hot-wire deposition device with extended focal-zone laser beam according to claim 5, wherein the lens assembly further comprises a planar mirror or an integral mirror, where the planar mirror or the integral mirror is configured to change a processing direction or laser energy distribution of the extended focal-zone laser beam.
